(19) United States
(12) Patent Application Publication
(10) Pub. No.: US 2025/0211036 A1
(43) Pub. Date: Jun. 26, 2025

(54) STATOR, MOTOR, COMPRESSOR, REFRIGERATION CYCLE APPARATUS, AND MANUFACTURING METHOD OF STATOR

(71) Applicant: Mitsubishi Electric Corporation, Tokyo (JP)

(72) Inventor: Tomoki MASUKO, Tokyo (JP)

(21) Appl. No.: 18/846,874

(22) PCT Filed: Mar. 28, 2022
(86) PCT No.: PCT/JP2022/014913

§ 371 Date: Sep. 13, 2024

(51) Int. Cl. H02K 1/16; F25B 31/02; H02K 15/027; H02K 21/14

(52) U.S. Cl. CPC H02K 1/16; F25B 31/026; H02K 15/027; H02K 21/14; H02K 2213/03

(57) ABSTRACT

A stator core includes slots, and further includes a first cutout portion, two second cutout portions and two third cutout portions are formed on the outer circumference of the stator core. A center of the first cutout portion in the circumferential direction and a center of each second cutout portion in the circumferential direction are at an angle of 90 degrees with respect to the center axis. The two third cutout portions are formed on both sides of a straight line passing though the center axis and the center of the first cutout portion. A first contact portion in contact with a shell is formed between the two third cutout portions. When D1 represents a minimum distance from the first contact portion to its closes slot, and D2 represents a minimum distance from each third cutout portion to its closet slot, 1.00≤D1/D2≤1.60 is satisfied.

### CROSS REFERENCE TO RELATED APPLICATION

This application is a U.S. national stage application of PCT/JP2022/014913 filed on Mar. 28, 2022, the contents of which are incorporated herein by reference.

### TECHNICAL FIELD

The present disclosure relates to a stator, a motor, a compressor, a refrigeration cycle apparatus, and a manufacturing method of the stator.

### BACKGROUND

A stator of a motor has a stator core made of stacked core sheets. The core sheets are formed by being punched from an electromagnetic steel sheet. In order to reduce the material cost of the core sheets, Patent Reference 1 discloses a stator core having five cutout portions formed on its outer circumference.

### PATENT REFERENCE

Patent Reference 1: Japanese Patent Publication No. 4717089 (see FIGS. 6 and 7)

In the case of the motor used in a compressor, the outer circumference of the stator core is fixed to a shell of the compressor. Thus, depending on the positions of the cutout portions, magnetic flux leakage from the stator core to the shell may occur, and the motor efficiency may decrease.

### SUMMARY

The present disclosure has an object to reduce the material cost and to suppress the reduction in motor efficiency.

A stator of the present disclosure includes a stator core having an outer circumference extending in a circumferential direction about a center axis and a plurality of slots arranged in the circumferential direction. The outer circumference is fixed to an inner side of a cylindrical shell. A first cutout portion, two second cutout portions and two third cutout portions are formed on the outer circumference of the stator core. The two second cutout portions are formed on both sides of the first cutout portion in the circumferential direction so that a center of the first cutout portion in the circumferential direction and a center of each second cutout portion in the circumferential direction are at an angle of 90 degrees with respect to the center axis. The two third cutout portions are formed on both sides of a straight line passing through the center axis and the center of the first cutout portion. A first contact portion that is in contact with the shell is formed between the two third cutout portions. The first contact portion is located on the straight line. When D1 represents a minimum distance from the first contact portion to one of the plurality of slots which is closest to the first contact portion, and D2 represents a minimum distance from each third cutout portion to one of the plurality of slots which is closest to the third cutout portion, 1.00≤D1/D2≤1.60 is satisfied.

In the present disclosure, the first, second, and third cutout portions are formed on the outer circumference of the stator core, and thus it is possible to reduce material waste in the punching step of the core sheets that constitute the stator core and to thereby reduce the material cost. In addition, since the minimum distances D1 and D2 satisfy 1.00≤D1/D2≤1.60, magnetic flux leakage to the shell can be reduced, and iron loss can also be reduced. That is, the material cost can be reduced, and the reduction in motor efficiency can be suppressed.

### BRIEF DESCRIPTION OF THE DRAWINGS

FIG. 1 is a cross-sectional view illustrating a motor of a first embodiment.

FIG. 2 is a cross-sectional view illustrating a rotor of the first embodiment.

FIG. 3 is a diagram for explaining an arrangement of cutout portions of a stator core of the first embodiment.

FIG. 4 is a flowchart illustrating a manufacturing method of the motor of the first embodiment.

FIG. 5 is a plan view illustrating an electromagnetic steel sheet from which core sheets of the first embodiment are punched.

FIG. 6 is a cross-sectional view illustrating a motor of Comparative Example.

FIG. 7 is a plan view illustrating an electromagnetic steel sheet from which core sheets of Comparative example are punched.

FIG. 8 is a graph showing the relationship between D1/D2 and iron loss.

FIGS. 9(A) and 9(B) illustrate analysis results of magnetic flux distribution in the stator core, corresponding to points A and B in FIG. 8, respectively.

FIG. 10 is a graph showing the relationship between D4/D3 and iron loss and the use amount of the steel sheet.

FIGS. 11(A), 11(B), and 11(C) illustrate analysis results of the magnetic flux distribution in the stator core, corresponding to points A, B, and C in FIG. 10, respectively.

FIG. 12 is a graph showing the relationship between D4/D3 and iron loss and the use amount of the steel sheet.

FIGS. 13(A), 13(B), and 13(C) illustrate analysis results of the magnetic flux distribution in the stator core, corresponding to points A, B, and C in FIG. 12, respectively.

FIG. 14 is a graph showing the relationship between D4/D3 and iron loss and the use amount of the steel sheet.

FIGS. 15(A), 15(B), and 15(C) illustrate analysis results of the magnetic flux distribution in the stator core, corresponding to points A, B, and C in FIG. 14, respectively.

FIG. 16 is a diagram illustrating a compressor of a second embodiment.

FIG. 17 is a diagram illustrating a refrigeration cycle apparatus of a third embodiment.

### DETAILED DESCRIPTION

### First Embodiment

### (Configuration of Motor)

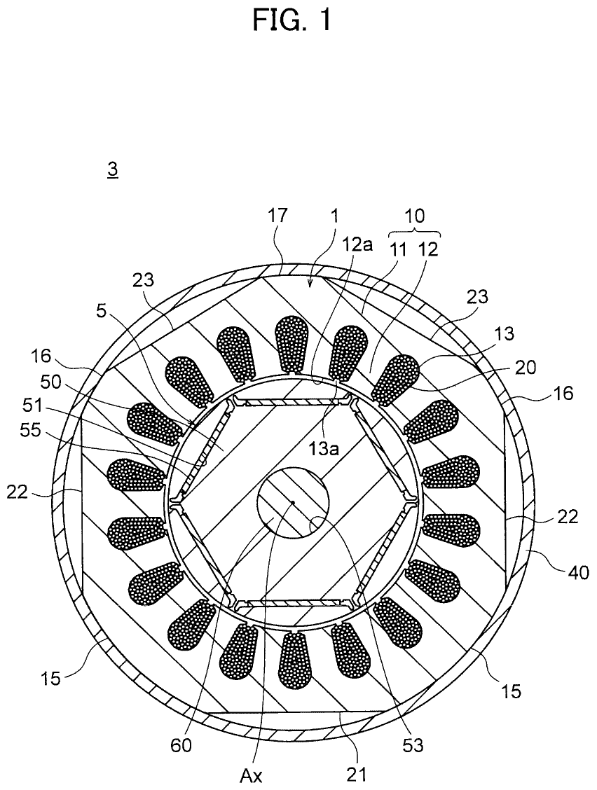

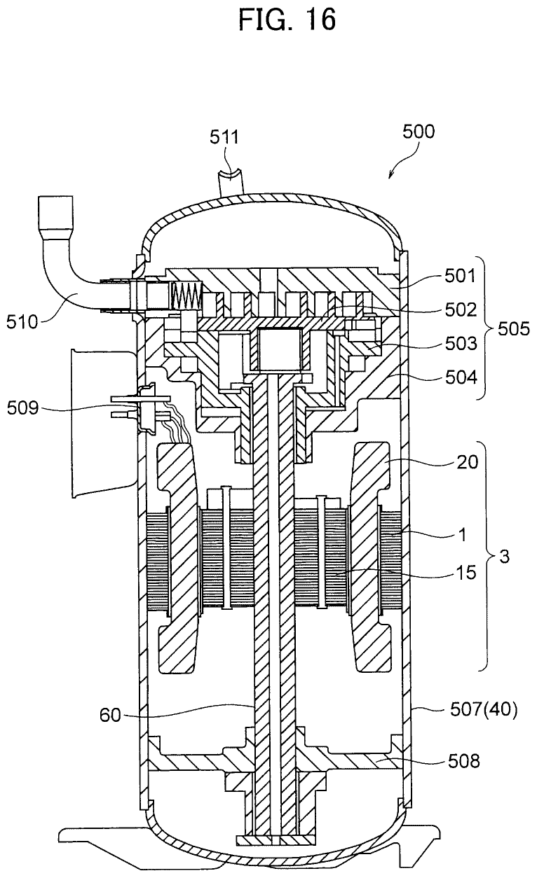

FIG. 1 is a cross-sectional view illustrating a motor 3 of a first embodiment. The motor 3 of the first embodiment is incorporated in, for example, a compressor 500 (FIG. 16). The motor 3 includes a rotatable rotor 5 and an annular stator 1 surrounding the rotor 5. An air gap is provided between the stator 1 and the rotor 5.

Hereinafter, the direction of a center axis Ax, which is a rotation center of the rotor 5, is referred to as an “axial direction”. The circumferential direction about the center axis Ax is referred to as a “circumferential direction”. The radial direction about the center axis Ax is referred to as a “radial direction”. In this regard, FIG. 1 shows a cross section perpendicular to the axial direction.

### (Configuration of Rotor)

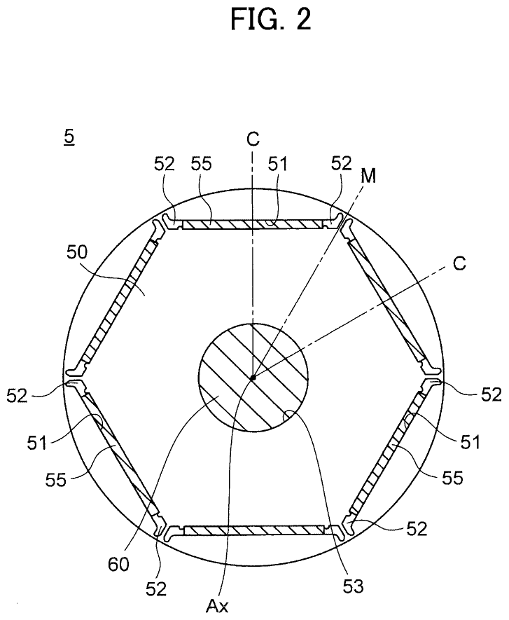

FIG. 2 is a cross-sectional view illustrating the rotor 5. The rotor 5 includes a rotor core 50 and permanent magnets 55 embedded in the rotor core 50. The rotor core 50 has a cylindrical shape about the center axis Ax. The rotor core 50 is made of a plurality of core sheets stacked in the axial direction and fixed integrally by crimping, rivets, or the like. The core sheets are, for example, electromagnetic steel sheets. The sheet thickness of each core sheet is, for example, 0.1 to 1.0 mm.

A center hole 53 is formed at the center of the rotor core 50 in the radial direction. A shaft 60 is fixed to the center hole 53 by press-fitting. A center axis of the shaft 60 is the center axis Ax described above.

The rotor core 50 has a plurality of magnet insertion holes 51 along its outer circumference. In this example, six magnet insertion holes 51 are arranged at equal intervals in the circumferential direction. One permanent magnet 55 is disposed in each magnet insertion hole 51.

Each permanent magnet 55 constitutes one magnetic pole. The number of permanent magnets 55 is six, and the number of poles of the rotor 5 is six. In this regard, the number of poles of the rotor 5 is not limited to six and only needs to be two or more. Two or more permanent magnets 55 may be disposed in one magnet insertion hole 51, and the two or more permanent magnets 55 may constitute one magnetic pole.

The center of each magnet insertion hole 51 in the circumferential direction is a pole center C. In this example, the magnet insertion hole 51 extends in a direction perpendicular to a straight line (i.e., pole center line) passing through the pole center C and the center axis Ax. However, the magnet insertion hole 51 may extend in a V shape which is convex toward the inner side in the radial direction. A space between adjacent magnet insertion holes 51 is an inter-pole portion M.

The permanent magnet 55 has a flat plate shape and has a width in the circumferential direction and a thickness in the radial direction. The permanent magnet 55 is a rare earth magnet, more specifically, a neodymium rare earth magnet that contains neodymium (Nd), iron (Fe) and boron (B). The permanent magnet 55 is magnetized in its thickness direction. The permanent magnets 55 that are adjacent in the circumferential direction have their magnetization directions opposite to each other.

A flux barrier 52 is formed at each end of the magnet insertion hole 51 in the circumferential direction. The flux barrier 52 is an opening that extends in the radial direction from the end of f the magnet insertion hole 51 in the circumferential direction toward the outer circumference of the rotor core 50. The flux barriers 52 function to reduce magnetic flux leakage between adjacent magnetic poles.

Although not shown in the figure, through holes may be formed on the inner side of the magnet insertion hole 51 of the rotor core 50 in the radial direction. Each through hole is used as a passage for refrigerant in the compressor or as an insertion hole for a rivet or the like. The number and arrangement of through holes are not limited.

### (Configuration of Stator)

As illustrated in FIG. 1, the stator 1 includes a stator core 10 having an annular shape about the center axis Ax and coils 20 wound on the stator core 10. The stator core 10 is made of a plurality of core sheets stacked in the axial direction and fixed integrally by crimping or the like. The core sheets are, for example, electromagnetic steel sheets. The thickness of each core sheet is, for example, 0.1 to 1.0 mm.

The stator core 10 has an annular core back 11 and a plurality of teeth 12 extending inward in the radial direction from the core back 11. An outer circumference of the core back 11 is fitted to an inner circumferential surface of a cylindrical shell 40. The shell 40 is a part of a hermetic container 507 of the compressor 500 (FIG. 16).

The teeth 12 are formed at equal intervals in the circumferential direction. Each tooth 12 has, on its inner side in the radial direction, a tooth tip portion 12a facing the rotor 5. The number of teeth 12 is 18 in this example, but only needs to be two or more.

A slot 13 is formed between adjacent teeth 12. The slot 13 has a slot opening 13a adjacent to the tooth tip portion 12a of the tooth 12 and extends outward in the radial direction from the slot opening 13a. The number of slots 13 is the same as the number of teeth 12, which is 18 in this example. The coils 20 are housed in the slots 13.

The coil 20 is wound around the tooth 12 via a not-shown insulating part and housed in the slot 13. A winding method of the coil 20 may be either distributed winding or concentrated winding. The coil 20 is made of a copper wire or an aluminum wire.

The insulating part provided between the coil 20 and the tooth 12 is made of a resin such as polybutylene terephthalate (PBT) or polyethylene terephthalate (PET). It is also possible to use an insulating film.

Five cutout portions are formed in the circumferential direction on the outer circumference of the core back 11. More specifically, one cutout portion 21, two cutout portions 22, and two cutout portions 23 are formed on the outer circumference of the core back 11.

Each of the cutout portions 21, 22, and 23 extends straight in a plane perpendicular to the center axis Ax. In other words, each of the cutout portions 21, 22, and 23 forms a flat surface parallel to the center axis Ax.

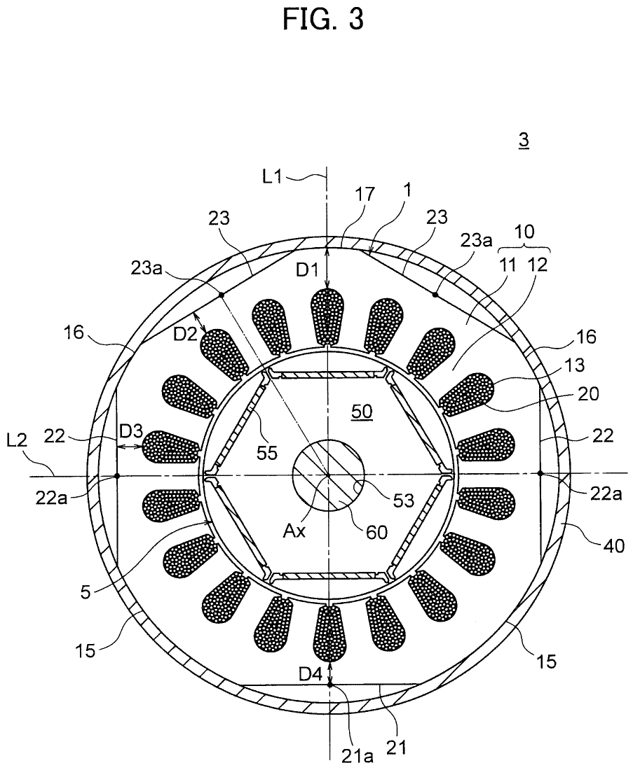

FIG. 3 is a diagram for explaining an arrangement of the cutout portions 21, 22, and 23 in the stator core 10. The cutout portion 21 is formed at one location on the outer circumference of the core back 11 (in this example, on the lower side in FIG. 3).

The cutout portions 22 are formed on both sides of the cutout portion 21 in the circumferential direction. A center 21a of the cutout portion 21 in the circumferential direction and a center 22a of each cutout portion 22 in the circumferential direction are at an angle of 90 degrees with respect to the center axis Ax. In other words, a straight line L1 passing through the center 21a of the cutout portion 21 and the center axis Ax is perpendicular to a straight line L2 passing through the center 22a of each cutout portion 22 and the center axis Ax.

The cutout portions 23 are formed on the side opposite to the cutout portion 21 across the center axis Ax. The cutout portions 23 are formed on both sides of the straight line L1 passing through the center 21a of the cutout portion 21 and the center axis Ax.

In an example illustrated in FIG. 3, the center 22a of the cutout portion 22 in the circumferential direction and a center 23a of the cutout portion 23 in the circumferential direction are at an angle of 60 degrees with respect to the center axis Ax. In this regard, the angle is not limited to 60 degrees and only needs to be less than 90 degrees.

The cutout portion 21 is also referred to as a “first cutout portion”, each cutout portion 22 is also referred to as a “second cutout portion”, and each cutout portion 23 is also referred to as a “third cutout portion”.

In the outer circumference of the core back 11, a contact portion 15 is formed between the cutout portion 21 and the cutout portion 22. A contact portion 16 is formed between the cutout portion 22 and the cutout portion 23. A contact portion 17 is formed between the two cutout portions 23. The contact portions 15, 16, and 17 form contact surfaces that contact the inner circumferential surface of the shell 40.

Each of the contact portions 15, 16, and 17 extends in an arc shape in a plane perpendicular to the center axis Ax. In other words, each of the contact portions 15, 16, and 17 is a part of a cylindrical surface about the center axis Ax.

The contact portions 15 and 16 are formed on each side of the straight line L1. One contact portion 17 is formed on the straight line L1. The contact portion 17 is also referred to as a “first contact portion”. Each contact portion 16 is also referred to as a “second contact portion”, and the contact portion 15 is also referred to as a “third contact portion”.

D1 represents the minimum distance from the contact portion 17 to the slot 13 which is closest to the contact portion 17. In this regard, the minimum distance from the contact portion 15 to the slot 13 which is closest to the contact portion 15 is equal to D1 described above. In addition, the minimum distance from the contact portion 16 to the slot 13 which is closest to the contact portion 16 is also equal to D1 described above.

Meanwhile, D2 represents the minimum distance from the cutout portion 23 to the slot 13 which is closest to the cutout portion 23. In addition, D3 represents the minimum distance from the cutout portion 22 to the slot 13 which is closest to the cutout portion 22. Further, D4 represents the minimum distance from the cutout portion 21 to the slot 13 which is closest to the cutout portion 21.

The contact portions 15, 16, and 17 form arcs of a circle about the center axis Ax, whereas the cutout portions 21, 22, and 23 correspond to chords of the circle. Thus, each of the minimum distances D2, D3, and D4 is shorter than the minimum distance D1.

The minimum distances D1 and D2 satisfy 1.00≤D1/D2≤1.60. The reason for this is described later.

### (Manufacturing Method)

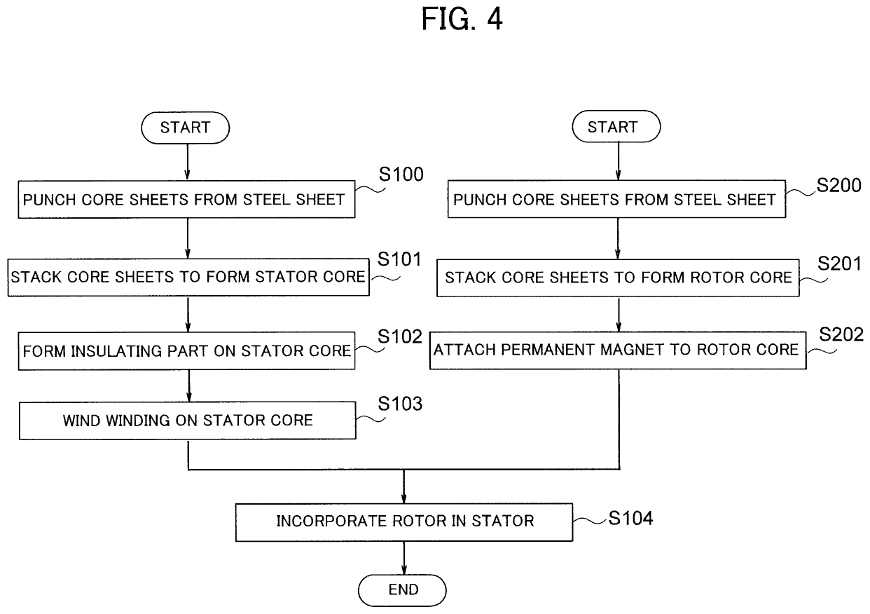

Next, a manufacturing method of the motor 3 will be described. FIG. 4 is a flowchart illustrating the manufacturing method of the motor 3. First, core sheets 101 for the stator core 10 are punched from an electromagnetic steel sheet by a press processing machine (step S100). The shape of the core sheet 101 is the same as that of the stator core 10 described with reference to FIGS. 1 and 3.

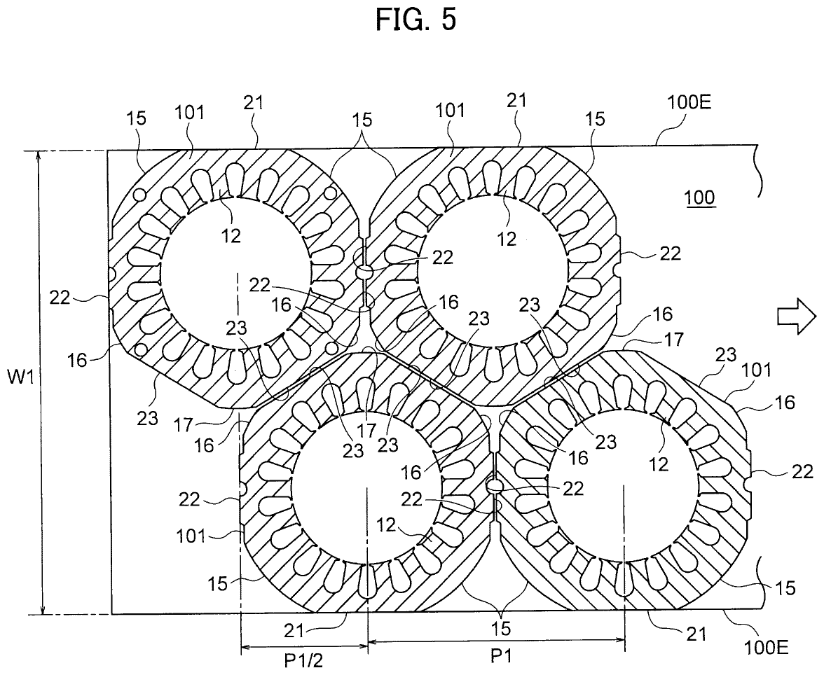

FIG. 5 is a diagram illustrating an electromagnetic steel sheet 100 from which the core sheets 101 are punched. As illustrated in FIG. 5, the electromagnetic steel sheet 100 is a strip-shaped steel sheet that is elongated in one direction and has a width W1 in a direction perpendicular to the longitudinal direction.

The core sheets 101 are punched from the electromagnetic steel sheet 100 in 2N rows (N is an integer). FIG. 5 illustrates a case where the core sheets 101 are punched from the electromagnetic steel sheet 100 in two rows (i.e., N=1), but they may be punched in four or six rows, or the like.

The core sheets 101 belonging to the same row are punched so that their cutout portions 22 face each other. The distance between the centers of the adjacent core sheets 101 belonging to the same row is referred to as a pitch P1. The core sheets 101 of the first row and the second row are punched in such a manner as to be displaced from each other by a distance corresponding to a half of the pitch P1 (i.e., P1/2) in the longitudinal direction of the electromagnetic steel sheet 100.

The core sheet 101 of the first row and the core sheet 101 of the second row have such a positional relationship that they are inverted by 180 degrees relative to each other. In other words, the cutout portion 23 of the core sheet 101 of the first row and the cutout portion 23 of the core sheet 101 of the second row are positioned to face each other. The cutout portion 21 of each core sheet 101 faces its corresponding end 100E of the electromagnetic steel sheet 100 in the width direction.

In this way, the cutout portion 23 of the core sheet 101 of the first row and the cutout portion 23 of the core sheet 101 of the second row face each other, and these cutout portions 23 are both straight. Thus, the core sheets 101 of the first row and the second row can be punched so that the centers of the core sheets 101 of the first row and the centers of the core sheets 101 of the second raw are close to each other in the width direction. Consequently, the width W1 of the electromagnetic steel sheet 100 can be narrowed.

In an example illustrated in FIG. 5, the core sheets 101 are punched in two rows from the electromagnetic steel sheet 100. However, the core sheets 101 may be punched in four or more rows. That is, N may be two or more. In such a case, the core sheets 101 are punched in a pattern where N sets, each including two rows as illustrated in FIG. 5, are arranged in the width direction.

In the example shown in FIG. 5, the core sheets 101 for the stator core 10 are punched from the electromagnetic steel sheet 100. Core sheets for the rotor core 50 may also be punched from an inner area of the core sheet 101. In this way, the material cost can be further reduced.

After the core sheets 101 are punched from the electromagnetic steel sheet 100 in this way, the core sheets 101 are stacked in the axial direction and fixed together by crimping or the like to form the stator core 10 (step S101 in FIG. 4). Thereafter, the insulating part (not shown) is formed in the stator core 10 (step S102), and the coils 20 are wound thereon (step S103). Consequently, the manufacturing of the stator 1 is completed. Steps S100 to S103 correspond to the manufacturing method of the stator 1.

In parallel with steps S100 to S103, the rotor 5 is manufactured. First, core sheets for the rotor core 50 are punched from an electromagnetic steel sheet (step S200). This step can be omitted in a case where the core sheets for the rotor core 50 and the core sheets 101 for the stator core 10 are both punched from the electromagnetic steel sheet 100 illustrated in FIG. 5.

Next, the core sheets are stacked in the axial direction and fixed together by crimping or the like to obtain the rotor core 50 (step S201). Then, the permanent magnets 55 are mounted in the magnet insertion holes 51 in the rotor core 50 (step S202). If necessary, a balance weight may be attached to the rotor core 50. Consequently, the manufacturing of the rotor 5 is completed.

The rotor 5 assembled in this way is incorporated inside the stator 1 (step S104). Thus, the manufacturing of the motor 3 is completed.

After the motor 3 is completed, the motor 3 is fixed to the inside of the shell 40 by shrink-fitting or the like. Specifically, the motor 3 is inserted into the shell 40 whose inner diameter is enlarged by heating, and then they are cooled. Consequently, the contact portions 15, 16, and 17 on the outer circumference of the stator core 10 are fixed to the inside of the shell 40.

### COMPARATIVE EXAMPLE

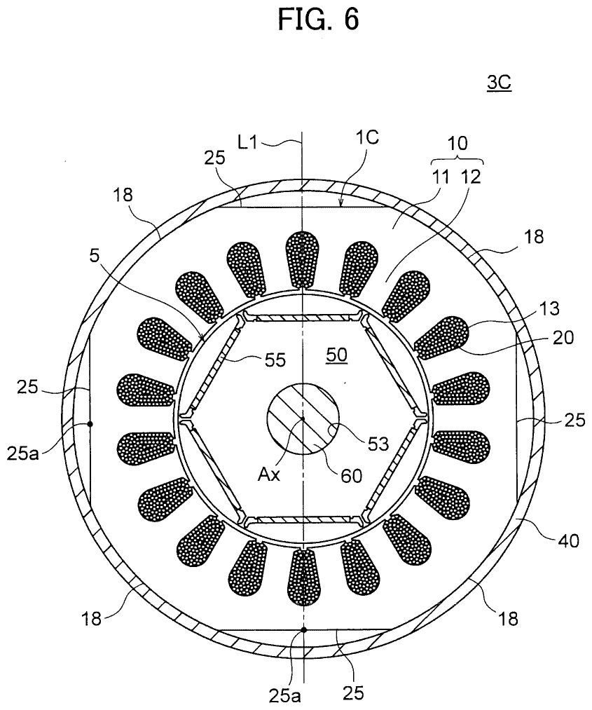

Next, a motor 3C of Comparative Example, which is compared with the motor 3 of the first embodiment, will be described. FIG. 6 is a diagram illustrating the motor 3C of Comparative Example. The motor 3C of Comparative Example has four cutout portions 25 on the outer circumference of the stator core 10. The cutout portions 25 are formed at equal intervals in the circumferential direction. Centers 25a of the cutout portions 25 adjacent to each other in the circumferential direction are at an angle of 90 degrees with respect to the center axis Ax.

An arc contact portion 18 is formed between the cutout portions 25 adjacent to each other in the circumferential direction. That is, four contact portions 18 are formed at equal intervals in the circumferential direction. In other respects, the motor 3C of Comparative Example is configured in the same way as the motor 3 of the first embodiment.

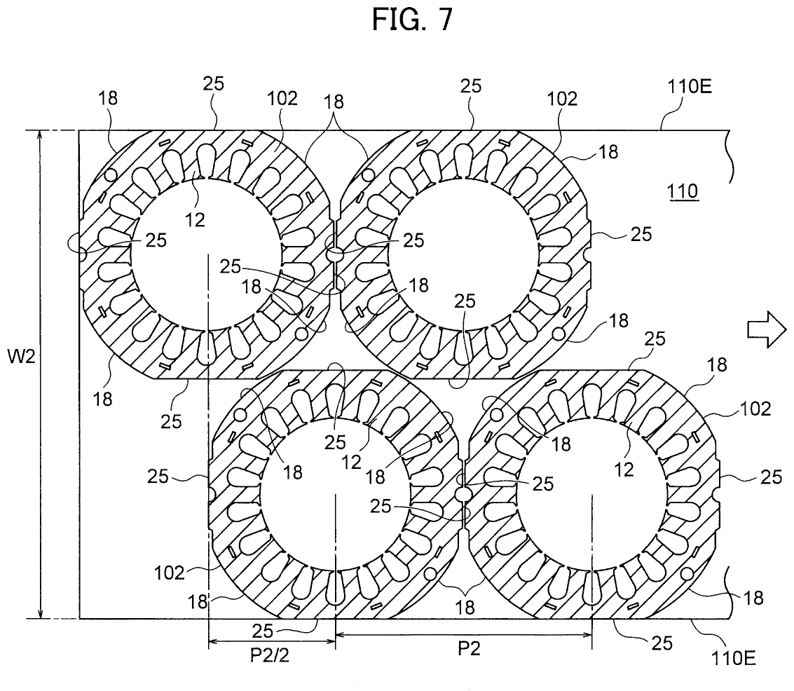

FIG. 7 is a plan view illustrating an electromagnetic steel sheet 110 from which core sheets 102 for constituting the stator core 10 of Comparative example are punched. As illustrated in FIG. 7, the core sheets 102 are punched from the electromagnetic steel sheet 110 in two rows.

The core sheets 102 belonging to the same row are punched so that the cutout portions 25 face each other. The distance between the centers of the adjacent core sheets 102 belonging to the same row is referred to as a pitch P2. The core sheets 102 of the first row and the second row are punched in such a manner as to be displaced from each other by a distance corresponding to a half of the pitch P2 (i.e., P2/2) in the longitudinal direction of the electromagnetic steel sheet 110.

In Comparative Example, the contact portion 18 of the core sheet 102 of the first row and the contact portion 18 of the core sheet 102 of the second row face each other, and these contact portions 18 have arc shapes. Thus, the distance in the width direction between the center of the core sheet 102 of the first row and the center of the core sheet 102 of the second row is difficult to decrease.

In contrast, in the first embodiment, the straight cutout portion 23 of the core sheet 101 of the first row and the straight cutout portion 23 of the core sheet 101 of the second row face each other as illustrated in FIG. 5, and thus the distance in the width direction between the centers of the core sheets 101 of the first and second rows can be shortened. Consequently, the width W1 of the electromagnetic steel sheet 100 can be narrowed, and the material cost can be reduced.

### (Optimal Range of D1/D2)

As described above, each of the distances D2, D3, and D4 from the cutout portions 23, 22, and 21 to the corresponding slots 13 is shorter than the minimum distance D1 from the contact portion 17 to the slot 13. If the distances D2, D3, and D4 are too short, portions having narrow widths in the radial direction may be formed in the core back 11, and a concentration of magnetic flux may occur thereat. If the concentration of the magnetic flux occurs in the core back 11, magnetic flux leakage to the shell 40 may also occur, and thus iron loss may increase.

Here, changes in iron loss in the shell 40 are examined by varying the ratio D1/D2 of the minimum distance D1 to the minimum distance D2. Each of the minimum distances D3 and D4 is set to be the same as the minimum distance D2 (D2=D3=D4).

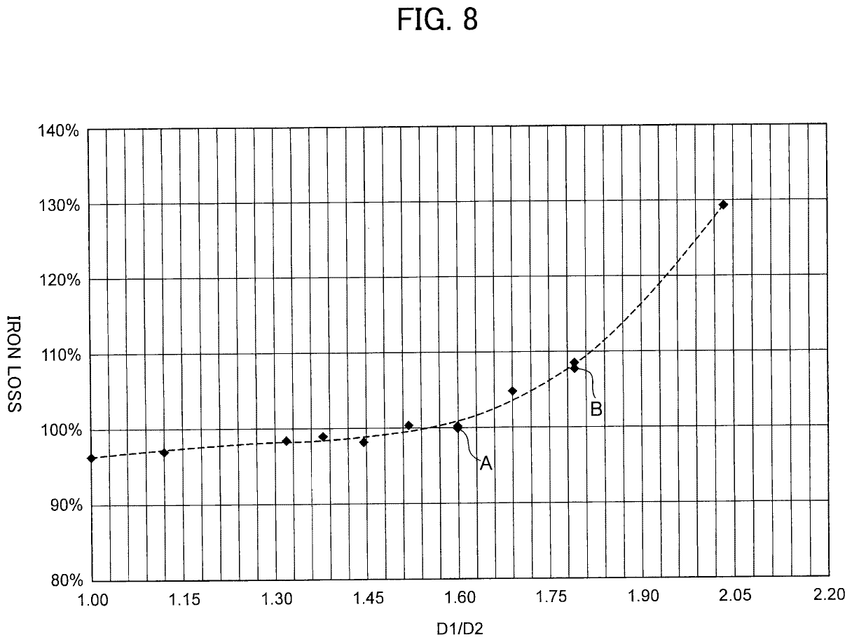

FIG. 8 is a graph showing change in iron loss when the ratio D1/D2 of the minimum distance D1 to the minimum distance D2 is varied. The horizontal axis indicates D1/D2, and the vertical axis indicates the iron loss in the shell 40. The iron loss is expressed as a relative value with respect to the iron loss at D1/D2=1.60, which is defined as the reference (100%).

In the analysis, the minimum distance D2 is varied from 6.45 mm to 14.95 mm, while the outer diameter of the stator core 10 is set to 159.5 mm and the minimum distance D1 is set to 14.95 mm. Each of the minimum distances D3 and D4 is set to be the same as the minimum distance D2.

As shown in FIG. 8, as the ratio D1/D2 increases, the iron loss increases accordingly. In particular, when D1/D2 increases from 1.00 to 1.60, the increase in iron loss is close to a straight line and has a small gradient. In contrast, when D1/D2 exceeds 1.60, the rate of increase in iron loss increases. Point A where D1/D2=1.60 corresponds to a point where the curvature changes.

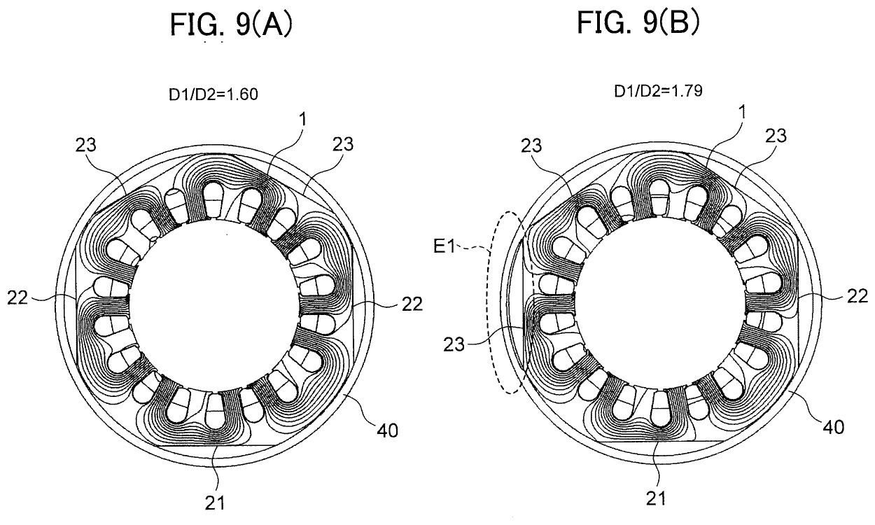

FIG. 9(A) is a diagram illustrating the analysis result of the magnetic flux distribution in the stator core 10 in the case of D1/D2=1.60 (point A in FIG. 8). FIG. 9(B) is a diagram illustrating the analysis result of the magnetic flux distribution in the stator core 10 in the case of D1/D2=1.79 (point B in FIG. 8).

In the case of D1/D2=1.60 (FIG. 9(A)), there is no magnetic flux leakage to the shell 40, or even if magnetic flux leakage occurs, it is at a level that does not cause a noticeable increase in iron loss in the shell 40. On the other hand, when D1/D2=1.79 (FIG. 9(B)), magnetic flux leakage to the shell 40 is at a level that causes a noticeable increase in iron loss in the shell 40, as indicated by reference character E1, for example.

This is because of the following reason. As D1/D2 increases, the widths of the portions of the core back 11 where the cutout portions 23 are formed are narrowed. Thus, a concentration of magnetic flux occurs in these portions, which causes a part of the magnetic flux to flow into the shell 40.

From the results shown in FIGS. 8 and 9(A) and 9(B), it is understood that the ratio D1/D2 of the minimum distance D1 to the minimum distance D2 is desirably within the range of 1.00≤D1/D2≤1.60.

### (Optimal Range of D4/D3)

Next, a description will be given of a ratio D4/D3 of the minimum distance D4 from the cutout portion 21 to the slot 13 to the minimum distance D3 from the cutout portion 22 to the slot 13. In the analysis shown in FIG. 8 described above, the minimum distances D4, D3, and D2 from the cutout portions 21, 22, and 23 to the corresponding slots 13 are set equal to each other. Here, the analysis is conducted depending on the size relationship between the minimum distance D4 from the cutout portion 21 to the slot 13 and the minimum distance D2 from the cutout portion 23 to the slot 13, i.e., in the cases of D2>D4, D2=D4, and D2<D4.

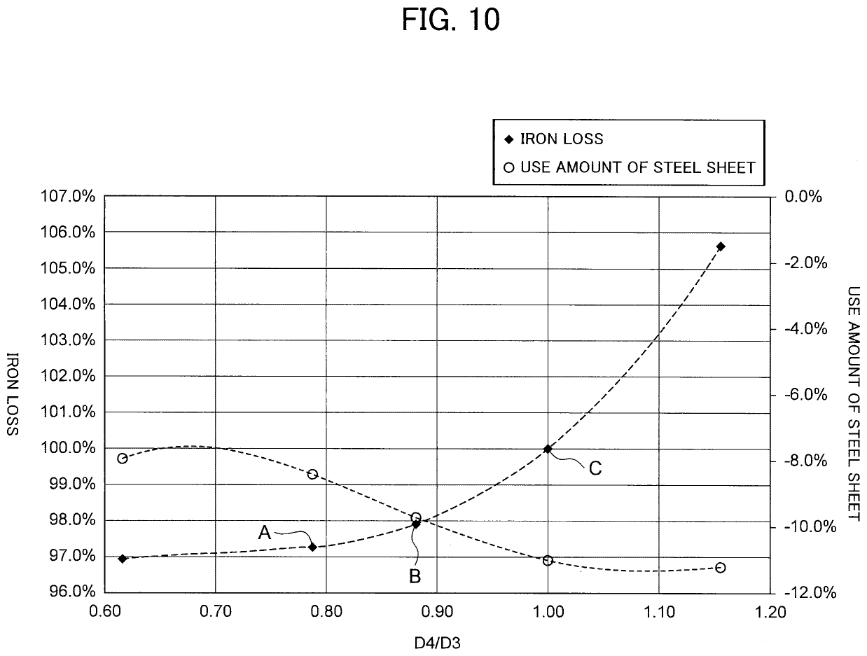

FIG. 10 is a graph showing change in iron loss when the ratio D4/D3 of the minimum distance D4 to the minimum distance D3 is varied in the case of D2>D4. The horizontal axis indicates D4/D3, the left vertical axis indicates the iron loss in the shell 40, and the right vertical axis indicates the use amount of the steel sheet. The iron loss is expressed as a relative value with respect to the iron loss at D4/D3=1.00, which is defined as the reference (100%). The use amount of the steel sheet is expressed as (W1−W2)/W2, i.e., the ratio of change in width W1 (FIG. 5) of the electromagnetic steel sheet, relative to a width W2 (FIG. 7) of the electromagnetic steel sheet in Comparative Example.

In the analysis, the minimum distance D3 is varied to 6.45 mm, 7.45 mm, 8.45 mm, 9.45 mm and 10.45 mm, while the outer diameter of the stator core 10 is set to 159.5 mm, the minimum distance D1 is set to 14.95 mm, the minimum distance D2 is set to 8.45 mm, and the minimum distance D4 is set to 7.45 mm. The ratio D2/D4 of the minimum distance D2 to the minimum distance D4 is 1.13.

As shown in FIG. 10, as D4/D3 increases, the iron loss increases accordingly. In particular, when D4/D3 exceeds 0.882, the rate of increase in iron loss is large. In other words, the curvature of a curved line where D4/D3 exceeds 0.882 is larger than the curvature of a curved line where D4/D3 increases from 0.617 to 0.882. Point B where D4/D3=0.882 corresponds to a point of change in curvature.

The use amount of the steel sheet increases when D4/D3 increases from 0.617 to 0.700 and then decreases when D4/D3 exceeds 0.700. Across the entire range of D4/D3, the use amount of the steel sheet is smaller than that in the Comparative Example, and thus yield is improved.

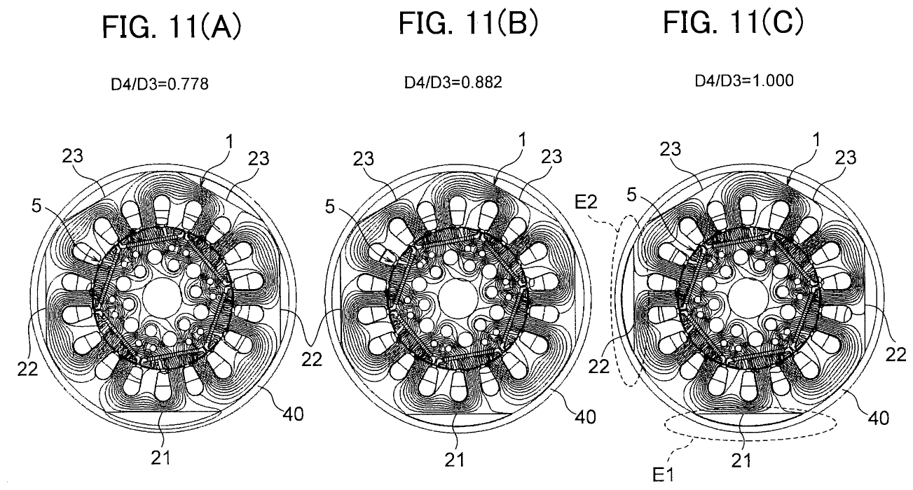

FIG. 11(A) is a diagram illustrating the analysis result of the magnetic flux distribution in the stator core 10 in the case of D4/D3=0.778 (point A in FIG. 10). FIG. 11(B) is a diagram illustrating the analysis result of the magnetic flux distribution in the stator core 10 in the case of D4/D3=0.882 (point B in FIG. 10). FIG. 11(C) is a diagram illustrating the analysis result of the magnetic flux distribution in the stator core 10 in the case of D4/D3=1.000 (point C in FIG. 10).

In both cases of D4/D3=0.778 (FIG. 11(A)) and D4/D3=0.882 (FIG. 11(B)), there is no magnetic flux leakage to the shell 40, or even if magnetic flux leakage occurs, it is at a level that does not cause a noticeable increase in iron loss in the shell 40. On the other hand, in the case of D4/D3=1.000 (FIG. 11(C)), magnetic flux leakage to the shell 40 is at a level that causes a noticeable increase in iron loss in the shell 40, as indicated by the reference characters E1 and E2, for example.

This is because of the following reason. Due to D2>D4, the width of the portion of the core back 11 where the cutout portion 22 is formed is narrowed. Further, as the D4/D3 increases, the widths of the portions of the core back 11 where the cutout portions 22 are formed are narrowed. Thus, a concentration of magnetic flux occurs in these portions, causing a part of the magnetic flux to flow into the shell 40.

From the results shown in FIGS. 10 and 11(A), 11(B), and 11(C), it is understood that in the case of D2>D4, the ratio D4/D3 of the minimum distance D4 to the minimum distance D3 is desirably within the range of 0.617<D4/D3≤0.882.

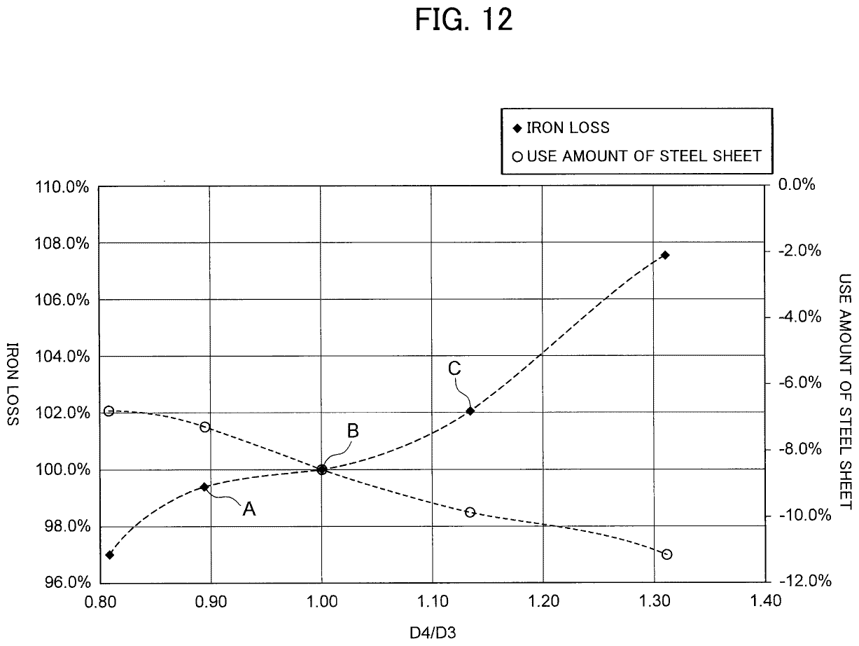

FIG. 12 is a graph showing change in iron loss when the ratio D4/D3 of the minimum distance D4 to the minimum distance D3 is varied in the case of D2=D4. The horizontal axis indicates D4/D3, the left vertical axis indicates the iron loss in the shell 40, and the right vertical axis indicates the use amount of the steel sheet. The iron loss is expressed as a relative value with respect to the iron loss at D4/D3=1.000, which is defined as the reference (100%). The use amount of the steel sheet is as described above with reference to FIG. 10.

In the analysis, the minimum distance D3 is varied to 6.45 mm, 7.45 mm, 8.45 mm, 9.45 mm and 10.45 mm, while the outer diameter of the stator core 10 is set to 159.5 mm, the minimum distance D1 is set to 14.95 mm, the minimum distance D2 is set to 8.45 mm, and the minimum distance D4 is set to 8.45 mm.

As shown in FIG. 12, as D4/D3 increases, the iron loss increases accordingly. In particular, when D4/D3 exceeds 1.000, the rate of increase in iron loss is large. In other words, the curvature of a curved line where D4/D3 exceeds 1.000 is larger than the curvature of a curved line where D4/D3 increases from 0.809 to 1.000. Point B where D4/D3=1.000 corresponds to a point where the curvature changes.

The use amount of the steel sheet decreases as D4/D3 increases. Across the entire range of D4/D3, the use amount of the steel sheet is smaller than that in Comparative Example, and thus yield is improved.

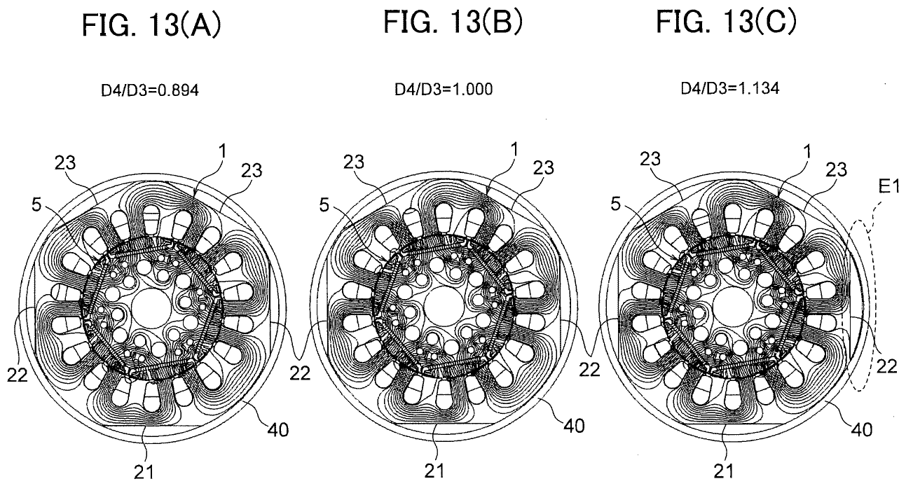

FIG. 13(A) is a diagram illustrating the analysis result of the magnetic flux distribution in the stator core 10 in the case of D4/D3=0.894 (point A in FIG. 12). FIG. 13(B) is a diagram illustrating the analysis result of the magnetic flux distribution in the stator core 10 in the case of D4/D3=1.000 (point B in FIG. 12). FIG. 13(C) is a diagram illustrating the analysis result of the magnetic flux distribution in the stator core 10 in the case of D4/D3=1.134 (point C in FIG. 12).

In both cases of D4/D3=0.894 (FIG. 13(A)) and D4/D3=1.000 (FIG. 13(B)), there is no magnetic flux leakage to the shell 40, or even if magnetic flux leakage occurs, it is at a level that does not cause a noticeable increase in iron loss in the shell 40. On the other hand, in the case of D4/D3=1.134 (FIG. 13(C)), magnetic flux leakage to the shell 40 is at a level that causes a noticeable increase in iron loss in the shell 40, as indicated by the reference character E1, for example.

This is because of the following reason. As D4/D3 increases, the widths of the portions of the core back 11 where the cutout portions 22 are formed are narrowed. This results in a concentration of magnetic flux in these portions, causing a part of the magnetic flux to flow into the shell 40.

From the results shown in FIGS. 12 and 13(A), 13(B), and 13(C), it is understood that in the case of D2=D4, the ratio D4/D3 of the minimum distance D4 to the minimum distance D3 is desirably within the range of 0.809≤D4/D3≤1.000.

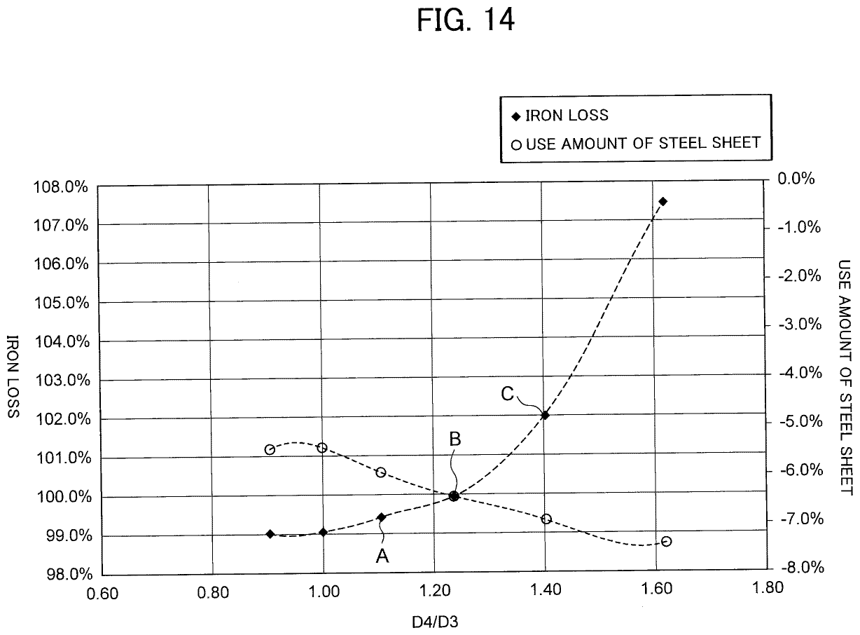

FIG. 14 is a graph showing change in iron loss when the ratio D4/D3 of the minimum distance D4 to the minimum distance D3 is varied in the case of D2<D4. The horizontal axis indicates D4/D3, the left vertical axis indicates the iron loss in the shell 40, and the right vertical axis indicates the use amount of the steel sheet. The iron loss is expressed as a relative value with respect to the iron loss at D4/D3=1.237, which is defined as the reference (100%). The use amount of the steel sheet is as described above with reference to FIG. 10.

In the analysis, the minimum distance D3 is varied to 6.45 mm, 7.45 mm, 8.45 mm, 9.45 mm and 10.45 mm, while the outer diameter of the stator core 10 is set to 159.5 mm, the minimum distance D1 is set to 14.95 mm, the minimum distance D2 is set to 8.45 mm, and the minimum distance D4 is set to 10.45 mm.

As shown in FIG. 14, as D4/D3 increases, the iron loss increases accordingly. In particular, when D4/D3 exceeds 1.237, the rate of increase in iron loss is large. In other words, the curvature of a curved line where D4/D3 exceeds 1.237 is larger than the curvature of a curved line where D4/D3 increases from 0.904 to 1.237. Point B where D4/D3=1.237 corresponds to a point where the curvature changes.

The use amount of the steel sheet decreases as D4/D3 increases. Across the entire range of D4/D3, the use amount of the steel sheet is smaller than that in Comparative Example, and thus yield is improved.

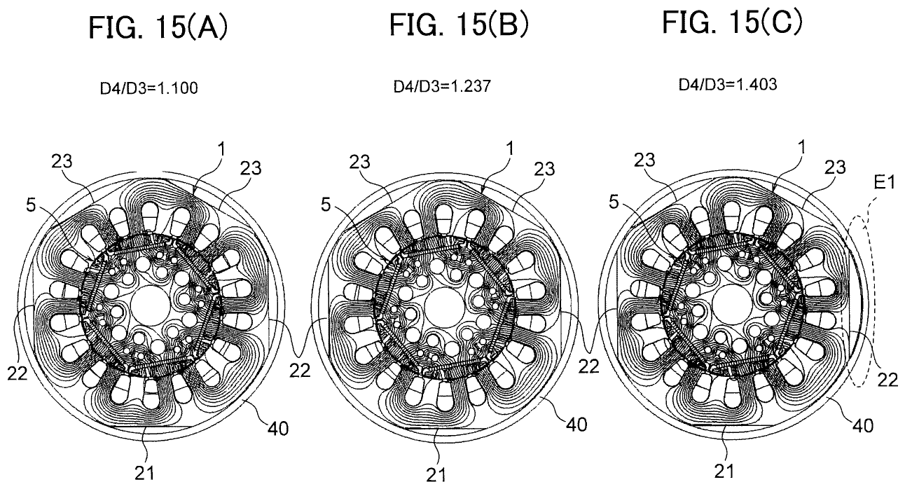

FIG. 15(A) is a diagram illustrating the analysis result of the magnetic flux distribution in the stator core 10 in the case of D4/D3=1.104 (point A in FIG. 14). FIG. 15(B) is a diagram illustrating the analysis result of the magnetic flux distribution in the stator core 10 in the case where D4/D3=1.237 (point B in FIG. 14). FIG. 15(C) is a diagram illustrating the analysis result of the magnetic flux distribution in the stator core 10 in the case of D4/D3=1.403 (point C in FIG. 14).

In both cases of D4/D3=1.104 (FIG. 15(A)) and D4/D3=1.237 (FIG. 15(B)), there is no magnetic flux leakage to the shell 40, or even if magnetic flux leakage occurs, it is at a level that does not cause a noticeable increase in iron loss in the shell 40. On the other hand, in the case of D4/D3=1.403 (FIG. 15(C)), magnetic flux leakage to the shell 40 is at a level that causes a noticeable increase in iron loss in the shell 40, as indicated by the reference character E1, for example.

This is because of the following reason. As D4/D3 increases, the widths of the portions of the core back 11 where the cutout portions 22 are formed are narrowed. This results in a concentration of magnetic flux in these portions, and causes a part of the magnetic flux to flow into the shell 40.

From the results shown in FIGS. 14 and 15(A), 15(B), and 15(C), it is understood that in the case of D2<D4, the ratio D4/D3 of the minimum distance D4 to the minimum distance D3 is desirably within the range of 0.904≤D4/D3≤1.237.

In this regard, the analysis described with reference to FIGS. 10, 12, and 14 is conducted within the range in which 0≤{(D1/Dmin)−(D1/Dmax)}≤0.8872 is satisfied, where Dmax is the longest among the minimum distances D2, D3, and D4, and Dmin is the shortest among the minimum distances D2, D3, and D4.

### Effects of Embodiment

As described above, the stator 1 of the first embodiment has, on the outer circumference of the stator core 10, the cutout portion 21 as the first cutout portion, two cutout portions 22 as the second cutout portions, and two cutout portions 23 as the third cutout portions. The cutout portions 22 are formed on both sides of the cutout portion 21 in the circumferential direction so that the center 21a of the cutout portion 21 and the center 22a of each cutout portion 22 are at an angle of 90 degrees with respect to the center axis Ax. The cutout portions 23 are formed on both sides of the straight line L1 passing through the center axis Ax and the center 21a of the cutout portion 21, and the contact portion 17 as the first contact portion is formed between these two cutout portions 23. When D1 represents the minimum distance from the contact portion 17 to the slot 13, and D2 represents the minimum distance from the cutout portion 23 to the slot 13, 1.00≤D1/D2≤1.60 is satisfied.

With this configuration, the core sheets 101 for constituting the stator core 10 can be punched from the electromagnetic steel sheet 100 in 2N rows with the narrow width W1, and thus the material cost can be reduced. Since the minimum distances D1 and D2 satisfy 1.00≤D1/D2≤1.60, magnetic flux leakage to the shell can be reduced, and iron loss can also be reduced. That is, the material cost can be reduced while suppressing the reduction in motor efficiency.

When D3 represents the minimum distance from the cutout portion 22 to the slot 13, and D4 represents the minimum distance from the cutout portion 21 to the slot 13, D2>D4 and 0.617≤D4/D3≤0.882 are satisfied, and thus the material cost can be reduced more effectively and the reduction in motor efficiency can be suppressed.

Furthermore, in a case where D2=D4 and 0.809≤D4/D3≤1.000 are satisfied, the material cost can be reduced more effectively, and the reduction in motor efficiency can be suppressed.

Furthermore, in a case where D2<D4 and 0.904≤D4/D3≤1.237 are satisfied, the material cost can be reduced more effectively, and the reduction in motor efficiency can also be suppressed.

The slot 13 is located on the inner side (i.e., on the center axis Ax side) in the radial direction of the center 17a of the contact portion 17, and thus the minimum distance from the cutout portion 23 on each of both sides of the contact portion 17 to the slot 13 can be increased. Therefore, the effect of reducing magnetic flux leakage to the shell 40 can be enhanced.

In addition, the tooth 12 is located on the inner side in the radial direction of the circumferential center 22a of the cutout portion 22, and thus the minimum distance from the cutout portion 22 to the slot 13 can be increased. Therefore, the effect of reducing magnetic flux leakage to the shell 40 can be enhanced.

Furthermore, the tooth 12 is located on the inner side in the radial direction of the circumferential center 23a of the cutout portion 23, and thus the minimum distance from the cutout portion 23 to the slot 13 can be increased. Therefore, the effect of reducing magnetic flux leakage to the shell 40 can be enhanced.

A manufacturing method of the stator 1 of the first embodiment includes the step of punching the core sheets 101 from the electromagnetic steel sheet 100, the step of stacking the core sheets 101 to form the stator core 10, and the step of winding the coils 20 on the stator core 10. In the punching step of the core sheets 101, the core sheets 101 are punched from the electromagnetic steel sheet 100 in 2N rows (N is an integer), with a constant pitch P in each row, in such a manner that the core sheet 101 of the first row and the core sheet 102 of the second row are displaced from each other by a distance corresponding to a half of the pitch P. Consequently, the core sheets 101 can be punched from the electromagnetic steel sheet 100 with the narrow width W1, and thus the material cost can be reduced.

In particular, in the punching step of the core sheets 101 described above, the core sheets 101 are punched so that the cutout portion 23 of the core sheet 101 of the first row and the cutout portion 23 of the core sheet 101 of the second row face each other, and thus the distance in the width direction between the centers of the core sheets 101 of the first and second rows can be shortened. Thus, the width W1 of the electromagnetic steel sheet 100 can be narrowed. Therefore, the effect of reducing the material cost can be enhanced.

### Second Embodiment

Next, the compressor 500 of a second embodiment will be described. The compressor 500 of the second embodiment includes the motor 3 of the first embodiment. FIG. 16 is a cross-sectional view illustrating the compressor 500. The compressor 500 is a scroll compressor in this example, but is not limited thereto.

The compressor 500 includes the hermetic container 507, a compression mechanism 505 that is disposed in the hermetic container 507, the motor 3 that drives the compression mechanism 505, the shaft 60 that connects the compression mechanism 505 and the motor 3, and a sub-frame 508 that supports a lower end of the shaft 60.

The compression mechanism 505 includes a fixed scroll 501 with a spiral portion, an orbiting scroll 502 with a spiral portion forming a compression chamber between the spiral portion of the fixed scroll 501 and the spiral portion of the orbiting scroll 502, a compliance frame 503 that holds an upper end of the shaft 60, and a guide frame 504 that is fixed to the hermetic container 507 to hold the compliance frame 503.

The fixed scroll 501 has a suction pipe 510 press-fitted thereto, and the suction pile 510 penetrates through the hermetic container 507. The hermetic container 507 is also provided with an outlet pipe 511 that allows high-pressure refrigerant gas discharged from the fixed scroll 501 to be discharged to the outside. The outlet pipe 511 communicates with a not-shown opening provided in the hermetic container 507 between the compression mechanism 505 and the motor 3.

The motor 3 is fixed to the hermetic container 507 by fitting the stator 1 into the hermetic container 507. The configuration of the motor 3 is as described above. A glass terminal 509 that supplies electric power to the motor 3 is fixed to the hermetic container 507 by welding.

When the motor 3 rotates, its rotation is transmitted to the orbiting scroll 502, causing the orbiting scroll 502 to oscillate. As the orbiting scroll 502 oscillates, the volume of the compression chamber formed by the spiral portions of the orbiting scroll 502 and the fixed scroll 501 changes. The refrigerant gas is then sucked through the suction pipe 510, compressed, and discharged through the outlet pipe 511.

Since the compressor 500 includes the motor 3 of the first embodiment which is low in cost and has high motor efficiency, the manufacturing cost of the compressor 500 can be reduced, and the operating efficiency of the compressor 500 can also be enhanced.

### Third Embodiment

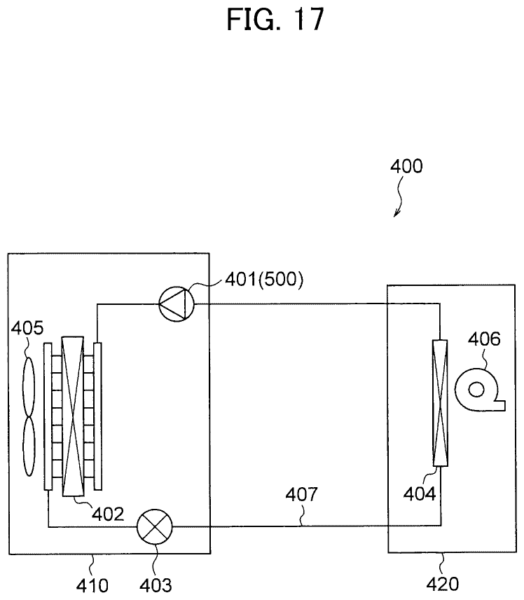

Next, a refrigeration cycle apparatus 400 of a third embodiment will be described. The refrigeration cycle apparatus 400 of the third embodiment includes the compressor 500 of the second embodiment. FIG. 17 is a diagram illustrating the refrigeration cycle apparatus 400. The refrigeration cycle apparatus 400 is, for example, an air conditioner, but is not limited thereto.

The refrigeration cycle apparatus 400 illustrated in FIG. 17 includes a compressor 401, a condenser 402 that condenses the refrigerant, a decompressor 403 that decompresses the refrigerant, and an evaporator 404 that evaporates the refrigerant. The compressor 401, the condenser 402, and the decompressor 403 are provided in an outdoor unit 410, and the evaporator 404 is provided in an indoor unit 420.

The compressor 401, the condenser 402, the decompressor 403, and the evaporator 404 are connected together by a refrigerant pipe 407 to constitute a refrigerant circuit. The compressor 401 is constituted by the compressor 500 illustrated in FIG. 16. The refrigeration cycle apparatus 400 also includes an outdoor fan 405 facing the condenser 402 and an indoor fan 406 facing the evaporator 404.

The operation of the refrigeration cycle apparatus 400 is as follows. The compressor 401 compresses the sucked refrigerant and discharges the compressed refrigerant as a high-temperature and high-pressure refrigerant gas. The condenser 402 exchanges heat between the refrigerant discharged from the compressor 401 and the outdoor air fed by the outdoor fan 405 to condense the refrigerant and discharges the condensed refrigerant as a liquid refrigerant. The decompressor 403 expands the liquid refrigerant discharged from the condenser 402 and then discharges the expanded refrigerant as a low-temperature and low-pressure liquid refrigerant.

The evaporator 404 exchanges heat between the low-temperature and low-pressure liquid refrigerant discharged from the decompressor 403 and the indoor air to evaporate the refrigerant and discharges it. Air from which the heat is taken in the evaporator 404 is supplied indoors, which is a space to be air-conditioned, by the indoor fan 406.

Since the compressor 401 of the refrigeration cycle apparatus 400 includes the motor 3 of the first embodiment, which is low-cost and has high motor efficiency, the manufacturing cost of the refrigeration cycle apparatus 400 can be reduced, and the operating efficiency of the refrigeration cycle apparatus 400 can be enhanced.

Although the desirable embodiments have been specifically described above, the present disclosure is not limited to the embodiments described above, and various modifications or changes can be made to these embodiments.

1. A stator comprising:
a stator core having an outer circumference extending in a circumferential direction about a center axis and a plurality of slots arranged in the circumferential direction, the outer circumference being fixed to an inner side of a cylindrical shell,
wherein a first cutout portion, two second cutout portions and two third cutout portions are formed on the outer circumference of the stator core,
wherein the two second cutout portions are formed on both sides of the first cutout portion in the circumferential direction so that a center of the first cutout portion in the circumferential direction and a center of each second cutout portion in the circumferential direction are at an angle of 90 degrees with respect to the center axis,
wherein the two third cutout portions are formed on both sides of a straight line passing through the center axis and the center of the first cutout portion, and a first contact portion is formed between the two third cutout portions, the first contact portion being in contact with the shell, the first contact portion being located on the straight line, and
wherein when D1 represents a minimum distance from the first contact portion to one of the plurality of slots which is closest to the first contact portion, and D2 represents a minimum distance from each third cutout portion to one of the plurality of slots which is closest to the third cutout portion,
1.00≤D1/D2≤1.60 is satisfied.

2. The stator according to claim 1, wherein when D3 represents a minimum distance from each second cutout portion to one of the plurality of slots which is closest to the second cutout portion, and D4 represents a minimum distance from the first cutout portion to one of the plurality of slots which is closest to the first cutout portion,
D2>D4 and 0.617≤D4/D3≤0.882 are satisfied.

3. The stator according to claim 1, wherein when D3 represents a minimum distance from each second cutout portion to one of the plurality of slots which is closest to the second cutout portion, and D4 represents a minimum distance from the first cutout portion to one of the plurality of slots which is closest to the first cutout portion,
D2=D4 and 0.809≤D4/D3≤1.000 are satisfied.

4. The stator according to claim 1, wherein when D3 represents a minimum distance from each second cutout portion to one of the plurality of slots which is closest to the second cutout portion, and D4 represents a minimum distance from the first cutout portion to one of the plurality of slots which is closest to the first cutout portion,
D2<D4 and 0.904≤D4/D3≤1.237 are satisfied.

5. The stator according to claim 1, wherein another one of the plurality of slots is located on the center axis side with respect to the center of the first contact portion in the circumferential direction.

6. The stator according to claim 1, wherein a tooth is located on the center axis side with respect to the center of each second cutout portion in the circumferential direction, the tooth being formed between two of the plurality of slots.

7. The stator according to claim 1, wherein a tooth is located on the center axis side with respect to a center of each third cutout portion in the circumferential direction, the tooth being formed between two of the plurality of slots.

8. A motor comprising:
the stator according to claim 1; and
a rotor provided inside the stator.

9. A compressor comprising:
the motor according to claim 8;
a compression mechanism driven by the motor; and
the shell surrounding the motor and the compression mechanism.

10. A refrigeration cycle apparatus comprising the compressor according to claim 9, a condenser, a decompressor, and an evaporator.

11. A manufacturing method of the stator according to claim 1, the manufacturing method comprising the steps of:
punching core sheets from an electromagnetic steel sheet;
stacking the core sheets to form a stator core; and
winding coils on the stator core,
wherein in the step of punching the core sheets, the core sheets are punched from the electromagnetic steel sheet in 2N rows (N is an integer) and at a constant pitch P in each row in such a manner that the core sheets of the first row and the second row are displaced from each other by a distance corresponding to a half of the pitch P.

12. The manufacturing method of the stator according to claim 11, wherein in the step of punching the core sheets, the core sheets are punched so that the third cutout portion of the core sheet of the first row and the third cutout portion of the core sheet of the second row face each other.
